(19) United States
(12) Patent Application Publication
(10) Pub. No.: US 2024/0375887 A1
(43) Pub. Date: Nov. 14, 2024

(54) TRANSPORT SYSTEM, APPARATUS COMPRISING A TRANSPORT SYSTEM, AND METHOD

(71) Applicant: Bausch + Stroebel SE + Co. KG, Ilshofen (DE)

(72) Inventors: Andreas Boehmike, Ilshofen (DE); Steffen Heier, Ilshofen (DE); Klaus Kaiser, Ilshofen (DE); Daniel Spieler, Ilshofen (DE); Sebastian Faerber, Ilshofen (DE); Manuel Wallisch, Ilshofen (DE)

(21) Appl. No.: 18/780,950

(22) Filed: Jul. 23, 2024

Related U.S. Application Data
(63) Continuation of application No. PCT/EP2023/051801, filed on Jan. 25, 2023.

(30) Foreign Application Priority Data
Jan. 28, 2022 (DE) 10 2022 102 058.4

(51) Int. Cl. B65G 47/90

(52) U.S. Cl. CPC B65G 47/90; B65G 2201/0235

(57) ABSTRACT

A transport system, apparatus and method are used to transport and process containers, such as pharmaceutical containers. The transport system has a transport path defining a transport direction. At least one station for the containers is positionable on the transport path. The station includes or defines container locations. Two or more transport devices are positioned one behind the other along the transport direction, each transport device having container receptacles and being designed to move back and forth along the transport direction in a clocked manner independently of one another and to transfer containers to and/or from the station. A control device controls the transport devices. A range of movement of the transport devices overlaps along the transport direction in such a way that at least some of the container locations of the station are reachable by two or more transport devices.

### CROSS-REFERENCE TO RELATED APPLICATIONS

This application is a continuation of International Application No. PCT/EP2023/051801, filed on Jan. 25, 2023, and claims priority to German Application No. 10 2022 102 058.4, filed on Jan. 28, 2022. The contents of International Application No. PCT/EP2023/051801 and German Application No. 10 2022 102 058.4 are incorporated by reference herein in their entireties.

### FIELD

The present invention relates to a transport system for transporting in particular pharmaceutical containers.

The present invention furthermore relates to an apparatus for processing in particular pharmaceutical containers with a transport system.

The present invention furthermore relates to a method for transporting in particular pharmaceutical containers.

### BACKGROUND

In an apparatus of the aforementioned kind, the containers run through different types of processing stations (which can also be referred to as processing devices), for example, from an inlet to an outlet. For example, the containers supplied via the inlet are first weighed, subsequently filled, weighed again, closed, and coupled out via the outlet. It is conceivable here that processing stations be combined spatially and functionally.

The containers can in particular be pharmaceutical containers, such as syringes, carpules, ampoules and/or vials. In the present case, “containers” can also include other types of packaging means, for example, cosmetic containers.

A transport system is typically used for transporting the containers in the apparatus. Transport systems for clocked transport, in which the containers can be moved forward in a plurality of groups or individually, are known. In this case, a so-called rake transport is known, in which the containers stand on a set-down element and, by “prongs” of the rake, which form feed elements, are moved further on step-by-step by one point of the rake in each clock cycle. Such a transport system proves to be less flexible. With a plurality of stations, the rake has large dimensions which entail difficulties with regard to mounting. Interim mounting points are required, which can lead to stresses. Positions of the containers at the individual stations are thereby not defined sufficiently precisely under certain circumstances. Any dimensional tolerances during the production of the components are also problematic.

A transport apparatus in which a transport rake and a counter rake, each with prongs, are used, is described in DE 10 2018 213 800 A1. Between respective prongs of the transport rake and of the counter rake, a container receptacle is formed, in which the containers, fixed to the two rakes, can be transported along a transport path.

### SUMMARY

It is an object of the present invention to provide a transport system, an apparatus comprising a transport system, and a method that enable a more versatile transport of the containers.

This object is achieved by a transport system in accordance with the invention for transporting in particular pharmaceutical containers, said transport system comprising:
a transport path which defines a transport direction, in particular from an inlet to an outlet, wherein at least one station for the containers is or can be positioned on the transport path and comprises or defines a plurality of container locations,
two or more transport devices positioned one behind the other along the transport direction, each of which comprises a plurality of container receptacles and is designed to be moved back and forth independently of one another in a clocked manner along the transport direction and to hand over containers to the at least one station and/or to take over containers from the at least one station, and
a control device for controlling the transport devices, wherein a range of movement of the transport devices overlaps along the transport direction in such a way that at least a portion of the container locations of the at least one station can be reached by means of two or more transport devices.

In the transport system in accordance with the invention, the containers can successively be transported in the transport direction by the two or more transport devices. For this purpose, the transport devices comprise container receptacles, which in particular each form a “transport location” for a container. By means of a first transport device, the containers can, for example, be transported up to the at least one station and handed over to them. With the second transport device, the containers can then be taken over from the station and transported on further. The station can, for example, be configured to be active or passive, wherein an active station is, for example, a weighing station, a filling station or a closing station, and a passive station is a set-down station or holding station for “temporarily parking” the containers. Due to the overlap of the ranges of movement, there is the possibility of taking over the containers, previously handed over by the first transport device, from the at least one station by the second transport device and to make the transport more versatile. The total range of movement can be divided into individual ranges of movement of the transport devices over the length of the transport path. This offers, for example, the possibility of keeping the masses for the two or more transport devices relatively low, just like the moments occurring during the movement. A faster transport of the containers is advantageously possible thereby. Due to the reduced dimensions in relation to conventional transport devices, for example the above-mentioned rake transport, component tolerances carry less weight. This facilitates the production of the transport system. Mounting the individual transport devices is favorably easier to implement than the mounting of a single transport device, for example in the above-described rake transport. In the event of any disturbances, for example, the individual transport devices can be stopped independently of one another, which proves to be advantageous for troubleshooting and preferably facilitates finding the cause of a fault. In the event of a fault, this can offer the advantage that not all containers in the transport system have to be discarded, but, for example, only containers of a disturbed transport device.

The transport devices can preferably be controlled independently of one another by the control device—this will be discussed below—so that corresponding movements of the transport devices can be specified independently of one another and preferably depending on the task. As a result, the transport system has a high versatility.

A further advantage of the invention can, for example, consist in the fact that the use of two or more transport devices reduces the risk of contamination being introduced over the transport path and can preferably be limited to range of movement of a single transport device.

It can prove advantageous if the transport path is linearly extended and the transport direction is linearly aligned, in particular from an inlet to an outlet.

It can be favorable if a range of movement of the transport devices overlaps along the transport direction such that all container locations of the at least one station can be reached by means of two or more transport devices. For example, all containers can be handed over from the first transport device to the station and all containers can be taken over from here by the second transport device.

A range of movement of the transport devices along the transport direction can, for example, overlap such that at least one of the transport devices can be positioned along the transport direction, at least in portions, on sides of the at least one station facing away from one another. In the present case, this can be understood in particular as meaning that the transport device can be positioned in a first position relative to one side of the at least one station and in a second position relative to the other side of the station. It is in particular conceivable here that at least one transport device can be moved completely past the station in at least one orientation along the transport direction.

It can be advantageous if the transport system comprises more than two transport devices positioned one behind the other in the transport direction and if the ranges of movement of three or more transport devices overlap, in such a way that at least some of the container locations of the at least one station can be reached by means of three or more transport devices. As a result, the transport system proves to be more versatile. For example, the containers can selectively be handed over to the at least one station and/or taken over from the at least one station by means of three or more transport devices.

It can be provided, for example, that in the case of two or more stations, in each case two adjacent transport devices of the transport system overlap with respect to their range of movement in such a way that at least some of the container locations can be reached at the respective station by the transport devices.

It can be favorable if at least one transport device can be controlled individually by the control device, preferably two or more and particularly preferably all transport devices. The control can preferably take place with regard to at least one of the following:
a travel path along the transport direction. The overlap of the ranges of movement of transport devices can favorably be adjustable. This makes it possible to specify which number of container locations can be achieved equally with two or more transport devices, for handing over the containers from/taking over the containers into the corresponding container receptacle;
a travel speed along the transport direction;
an acceleration along the transport direction;
a standstill time, during which the transport device is not moved along the transport direction;
a ratio of a travel time to a standstill time, for example in the sense of a pulse/pause ratio.

The individual control of at least one and preferably a plurality of transport devices leads to a high versatility of the transport system. Depending on the task to be performed, the control device can be programmed in such a way, for example the nature of the containers to be processed and/or the type of at least one station, that at least one of the following can be implemented: reliable transport, high throughput, short standstill time, flexibility in the number of containers taken over by the transport devices, for example upon handover to the station and/or upon takeover from the station.

As already mentioned, the transport devices can be moved along the transport direction. It can be favorable for the apparatus with the transport system if the at least one station is positioned in a stationary manner on the transport path relative to the transport direction. The containers can, to a certain extent, be “brought” to the station and can be “picked up” again by this station. For this purpose, it may be necessary, for example, to move the containers in a direction transverse or perpendicular to the transport direction. Such a movement can take place relative to the transport direction, for example, at an angle of inclination which can be more than 0° and can be, for example, up to 90°. An angle of inclination of approximately 40° to 90° is advantageously conceivable. The angle of inclination can preferably change during the movement to the station and/or away from the station. In particular, a linear movement, a curved movement or a movement along a polygonal line with straight segments, in each case having different angles of inclination relative to the transport direction, is conceivable.

It can be advantageous if at least one transport device, preferably two or more transport devices, and in particular all transport devices, can be controlled individually with regard to at least one of the following:
a movement of the containers transversely and/or perpendicularly to the transport direction for handing over the containers to the station and/or for taking over the containers from the station;
a travel speed and/or an acceleration here;
a standstill time, during which the transport device is positioned unmoved at the at least one station;
a ratio of a travel time to a standstill time here;
a time behavior for closing the container receptacles for receiving the containers and/or for opening the container receptacles for releasing the containers.

By one or more of the optional features of the invention described above, the versatility of the transport system can be increased. In particular, not only can the movement along the transport direction advantageously be individually controllable, but also a movement of the containers transversely and in particular perpendicularly to the transport direction, for example for the handover to the station and/or the takeover from the station.

The above statements show that favorably at least one transport device, preferably two or more transport devices and particularly preferably all transport devices, can be controlled by the control device with regard to a trajectory of the container receptacles during the movement of the transport device. In the present case, the trajectory can in particular be understood to mean a spatial curve of the container receptacles and thus also containers accommodated therein during transport in the transport system, in particular including standstill times at the at least one station.

As mentioned above, the control by the control device can be programmed. Alternatively or additionally, it is conceivable that the control, for example an existing programming, takes place depending on a signal supplied to the control device.

At least one transport device, preferably two or more transport devices, and in particular all transport devices, in a preferred embodiment, can be controlled individually by the control device depending on at least one of the following:
at least one movement parameter of at least one further transport device, for example location, speed, acceleration, and/or standstill time;
a type of the at least one station;
a dwell time of the containers at the at least one station;
a nature of the containers;
a handover duration for the handover of the containers to the at least one station;
a removal duration for removing the containers from the at least one station (takeover);
at least one input parameter of the control device, for example a signal, in particular an interference signal.

It can be provided, for example, that a relatively long dwell time is required depending on the type of station. For example, a weighing and filling process at a station with regard to process control is performed very carefully and thus takes up a relatively large amount of time. By contrast, a subsequent movement of the containers with a transport device can take place relatively quickly. A closing of the containers can, for example, also take up relatively little time and can thus be carried out quickly.

By individually controlling at least one transport device, the invention offers the possibility of differentiating from conventional transport systems in that a “machine clock cycle” there is attenuated or even canceled. In particular, a corresponding transport device can execute a dedicated clock cycle during operation, for example.

It is advantageous if the control of the at least one transport device, in particular of the two or more and preferably of all transport devices, can be changed during the operation of the transport system. This makes it possible for at least one of the transport devices to be moved in an individual and dynamic clock cycle, wherein individual trajectories of the containers can preferably be specified during operation.

A travel path of the transport devices along the transport direction is favorably adjustable independently of the number of container locations of the at least one station, preferably during operation of the transport system. In particular, it can be provided that the travel path can be predetermined independently of any number of container locations of the at least one station and/or the number of container receptacles of the transport devices.

It can be provided, for example, that the number of container receptacles of the transport devices corresponds to the number of container locations of the at least one station. In this case, during operation of the transport system, it is favorably provided that all container receptacles of the transport devices and all container locations of the stations are occupied.

The clocked transport of the containers via the transport devices, in particular in the last-mentioned advantageous embodiment, is executable, for example, in such a way that, by means of at least one of the transport devices, all containers held in the container receptacles—wherein in particular all container receptacles can be occupied by containers—can be handed over to the at least one station and/or all containers positioned at the container locations—wherein in particular all container locations can be occupied by containers—can be taken over from the at least one station. Such an embodiment can be advantageous, for example, in the case of a plurality of stations having an identical number of container locations corresponding to the number of container receptacles of the transport devices. A corresponding “package” of containers is transported in cycles from one station to the next station.

It goes without saying that the containers of a “package” are preferably free from one another and not connected to one another. The package can be or comprise a predetermined or predeterminable quantity of containers.

It can be provided that the number of container receptacles of the transport devices differs from the number of container locations of the at least one station. Here, for example, it can be provided that the number of container locations is smaller than the number of container receptacles. Such an embodiment can prove advantageous, for example, when several stations having different numbers of container locations are present. A “rapid” station with a rather short dwell time can have a smaller number of container locations and can be approached more frequently by the transport devices, and a “slow” station with a rather longer dwell time can have a higher number of container locations, by contrast, and can be approached less frequently by the transport devices.

In particular, in conjunction with the preferred embodiment of the last paragraph, it can be favorable if the clocked transport of the containers via the transport devices can be carried out in such a way that only some of the containers held in the container receptacles can be handed over to the at least one station by means of the transport devices and/or only some of the containers positioned at the container locations can be taken over from the at least one station.

The range of movement of at least one of the transport devices can, for example, be divided into grids, so that the containers can each be moved within a corresponding grid. Alternatively or additionally, it can be provided that the range of movement is grid-free and an individual positioning of the containers along the transport direction is possible.

Two or more transport devices are preferably configured identically. The production of the transport system is thereby simplified. Any fault finding when one of the transport devices is disrupted is facilitated. Differences in the movement behavior of the transport devices preferably occur solely as a result of the control by means of the control device.

A distance of adjacent container receptacles in the two or more transport devices and/or within a corresponding transport device preferably coincides. The transport devices can accordingly have an identical “pitch” and each transport device can have a constant “pitch”.

A distance of adjacent container locations of the at least one station preferably corresponds to a distance between the container receptacles of the transport devices. The station can accordingly have the same “pitch” as the transport devices.

Alternatively, a distance of adjacent container locations of the at least one station can be an integral multiple of the distance of the container receptacles of the transport devices from one another. This can be provided, for example, when the container locations occupy more space than the container receptacles or transport locations. For example, only 1/n of the containers are handed over to the station during a handover into the container locations, wherein n is the integer multiple, whereas the remaining containers are preferably temporarily parked at the station, for example at a set-down station or a holding station. A further proportion of 1/n containers can then be handed over to the container locations, etc., until all containers have been processed at the station. The movement of the transport device along the transport direction allows the corresponding container locations to be approached.

In particular, it is provided that the apparatus for processing the containers with the transport system has a uniform distance of container locations and container receptacles and accordingly a constant “pitch”.

The containers can be moved in discrete intervals along the transport direction and/or continuously via the at least one transport device. In the present case, “continuously” can be understood, for example, as “at arbitrarily small intervals” within the scope of the technical implementation of the transport device and the associated spatial resolution.

The spatial position of the container locations at the at least one station can be fixedly predetermined, for example at a weighing station by weighing cells, at a filling station by filling elements (for example filling needles) or at a closing station, or at a holding station for non-stable containers with discrete container receptacles.

Alternatively, it can be provided that the spatial position of the container locations at the at least one station can be freely predetermined, for example at a set-down station for stable containers.

Stable containers, for example vials, can be stood on a set-down element, for example. The situation is different with so-called non-stable containers which, due to their geometry, do not stand of their own accord and therefore have to be fixed in some other way. Non-stable containers include, for example, syringes (including possible needle protection), carpules or ampoules, wherein other types of packaging means are also conceivable.

It can be provided that a set-down station also has discrete, predetermined spatial positions of the container locations.

The transport system preferably has a pharmaceutically suitable design. For example, pharmaceutically suitable materials such as stainless steel or plastic can be used here.

It can be provided that two or more transport devices can be controlled by the control device such that said transport devices are simultaneously movable along the transport direction. In particular, movements can be provided in both orientations (in and counter to the transport direction). A movement in the same orientation or in mutually opposite orientations is conceivable.

Two or more transport devices can be controlled by the control device such that said transport devices can be moved synchronously along the transport direction, in particular at the same speed and/or the same acceleration.

Preferred embodiments of the transport devices are discussed below.

The transport devices comprise, for example, in each case at least one holding part and a plurality of holding elements, which form the container receptacles. The holding part can, for example, be designed to extend longitudinally, in particular as a tube or strip.

The holding elements are preferably releasably fixed to the at least one holding part. A connection and/or a release can preferably take place manually and/or without tools. For example, a positive-locking and/or force-locking connection is conceivable. The holding elements are, for example, fixable to the holding part in a latching and/or clamping manner. It can be provided, for example, that the holding elements can be snapped onto the holding part, wherein they have, in portions, a substantially C-shaped design. An anti-twist means for preventing a rotation of the holding elements relative to the holding part can be provided.

In conjunction with releasable holding elements, it can be advantageous if the transport system comprises two or more format sets which each comprise holding elements, wherein the holding elements of different format sets differ from one another with regard to at least one container-specific and/or container-component-specific property, wherein the holding elements of a corresponding format set can selectively be fixed to the holding parts. As a result, the transport system has a high versatility. A corresponding format set favorably covers a specific format range of containers. Different format ranges, for example as a result of different container types and/or container sizes, can be covered by exchanging the holding elements of another format set.

It can be advantageous if the transport device comprises two holding parts which are movable relative to one another in particular along the transport direction and on which holding elements are positioned in each case, wherein a corresponding container receptacle is formed by two holding elements, one holding element each on one of the holding parts. In this case, the container receptacle is formed by two holding elements, wherein one of the holding elements is fixed on a first holding part and one of the holding elements is fixed on a second holding part.

The holding parts are preferably designed to assume a holding position in which the containers are held in the container receptacles, and a release position in which the container receptacles are released. By moving the holding parts relative to one another, the container can be received and held on the one hand. By moving in the opposite direction, the container receptacle can be expanded in order to release the container.

The functional principle of the embodiment of the transport device described above is configured in particular as in the case of a so-called “transport rake” and “counter rake” as described, for example, in DE 10 2018 213 800 A1 mentioned at the outset. In particular, a holding part together with holding elements can here form a “transport rake”, the other holding part together with the holding elements can form the “counter rake”.

The transport device preferably comprises a drive unit for moving the transport device along the transport direction and/or for moving the holding parts relative to one another—for example, for assuming the holding position or the release position—and/or for moving the holding elements transversely and/or perpendicularly relative to the transport direction. The last-mentioned movement can in particular serve to hand over the containers to the station and/or to take them over from the station.

The functional principle of the drive unit can, for example, be implemented as described in DE 10 2018 213 800 A1.

In a preferred embodiment, the drive unit can comprise transport elements which are hingedly coupled to the holding parts, in particular to form a four-bar linkage, and drive elements which are preferably magnetically coupled to the transport elements and are movable on a transport path along the transport direction, for example are movable linearly. Such a design of the transport device is preferably found to be reliable. In the case of magnetic coupling, a pharmaceutically acceptable design can be achieved in a structurally simple manner. The drive elements can be positioned outside a clean space delimited by the transport path and the transport elements within the clean space. The coupling takes place via coupling elements which, for example, form a joint parallelogram with the transport element and the corresponding holding part or a coupling member positioned thereon. The drive elements can be displaceable along the transport direction via an electromagnetically configured transport path.

It can be favorable if at least one transport device can be controlled by the control device in such a way that the holding parts of the transport device can be moved independently of one another, for example along the transport direction and/or transversely and in particular perpendicularly thereto, for example for handing over containers and/or when taking over containers.

A control can take place, for example, in such a way that the holding elements of the one holding part and the holding elements of the other holding part have different types of trajectories, in particular depending on the containers to be processed.

For example, the holding elements for holding the container on a left side and a right side are shaped identically, but symmetrically to one another, for example for vials. In this case, the trajectories can be formed symmetrically to one another. By contrast, the holding elements for syringes for holding on a left side and a right side can be formed differently, asymmetrically relative to one another. In this case, it can be provided that the trajectories are asymmetrical, because the holding elements are to be moved in different ways depending on the shape for moving toward the syringe or away therefrom, so that the syringe can be gripped or released.

It can be favorable if the control device comprises a programming interface for an operator and/or a communication member for exchanging programming information with an external auxiliary unit having a programming interface, wherein programming information can be provided via the programming interface. This allows a simple and user-friendly adaptation of the transport system. Without the assumption of design changes of the transport devices, at most apart from different format parts, the operator can, for example, change the movement behavior of the transport devices.

As already mentioned, the present invention also relates to an apparatus.

An apparatus in accordance with the invention for processing in particular pharmaceutical containers comprises a transport system of the type described above and at least one station positioned on the transport path of the transport system.

The advantages which were already mentioned in conjunction with the explanation of the transport system in accordance with the invention can likewise be achieved with the apparatus in accordance with the invention. Advantageous embodiments of the apparatus in accordance with the invention result from advantageous embodiments of the transport system in accordance with the invention. In this regard, reference can be made to the above statements.

The at least one station can be configured to be active or passive. This has already been discussed above.

The apparatus can comprise more than one station, wherein the stations are positioned one behind the other on the transport path in the transport direction.

The at least one station can comprise, for example, at least one of the following:
a set-down station for setting down in particular stable containers;
a holding station for holding in particular non-stable containers;
a weighing station for weighing unfilled and/or filled containers;
a filling station for filling containers;
a closing station for closing containers;
a monitoring station. For example, the presence of a container, a closure element, the possible damage thereof, the correct seat of the closure element, the color of a substance in the container, or a different type of criterion is monitored for correctness. The monitoring station is, for example, optically configured and can comprise at least one camera.
a combination of two or more of the preceding stations, for example one station, at which both weighing and filling can be carried out;
an in-coupling station for taking over the containers, in particular by a transport device that is first in the transport direction;
an out-coupling station to which the containers can be handed over in particular through a station that is last in the transport direction.

The apparatus can comprise two or more stations, wherein the number of container locations of at least two stations is identical.

In combination with the last-mentioned embodiment, it can be preferred, for example, that a clocked transport can be carried out in such a way that, by means of the transport devices, all containers held in the container receptacles can be handed over to the at least one station and/or all containers positioned at the container locations can be taken over from the at least one station. In this case, all transport devices can run an identical clock cycle, for example in relation to the containers to be handed over/to be taken over.

The apparatus can comprise two or more stations, wherein the container locations of at least two stations differ from one another. In this case, it can in particular be provided that a station in which a longer dwell time exists for the containers during processing has a higher number of container locations than a station with a shorter dwell time. A long dwell time can, for example, comprise a filling station and/or a weighing station, wherein, for example, the dwell time of a closing station may be shorter.

The number of container receptacles of the transport devices can differ, in particular in the last-mentioned embodiment, from the number of container locations of a station, wherein a set-down station or a holding station is positioned laterally directly next to the station in the transport direction, and wherein some of the containers in the container receptacles are handed over from the transport device to the first-mentioned station, and some of the containers in the container receptacles can be handed over to the set-down station or the holding station. If more containers are held on the transport device than the first-mentioned station has container locations, the remaining containers can be “temporarily parked”, for example at the set-down station or the holding station. In a subsequent processing step, these containers can, for example, be taken over again and supplied to the first-mentioned station.

The transport devices preferably comprise such a high number of container receptacles that they correspond to the number of container locations of the station with the highest number of container locations.

As mentioned above, the present invention also relates to a method.

A method in accordance with the invention that achieves the object mentioned at the outset for transporting in particular pharmaceutical containers with a transport system of the type described above comprises the steps of:
transporting containers by means of a first transport device along the transport direction to at least one station in a first orientation;
handing over at least some of the containers from the transport device to the at least one station;
removing the first transport device from the at least one station in a second orientation opposite the first orientation;
moving a second transport device in the second orientation to the at least one station in such a way that the second transport device at least partially overlaps with the position of the first transport device beforehand;
taking over at least some of the containers from the at least one station by the second transport device;
moving the second transport device in the first orientation away from the at least one station.

The advantages already mentioned in conjunction with the explanation of the transport system in accordance with the invention can also be achieved by carrying out the method. Advantageous exemplary embodiments of the method result from advantageous embodiments of the transport system in accordance with the invention and the apparatus in accordance with the invention. In this respect, reference is made to the above statements.

### BRIEF DESCRIPTION OF THE DRAWINGS

The following description of preferred embodiments of the invention serves in conjunction with the drawing to explain the invention in more detail. In the figures:

FIG. 1: shows a schematic representation of an apparatus in accordance with the invention for processing containers, comprising a transport system in accordance with the invention, in each case in a preferred embodiment;

FIG. 2: shows a perspective partial representation of the transport system in which two transport devices and a set-down station for containers are shown;

FIG. 3: shows a plan view of the transport system in the viewing direction of the arrow “3” in FIG. 2, wherein a weighing station is additionally shown;

FIG. 4: shows a representation corresponding to FIG. 3 at a later point in time during processing of the containers;

FIG. 5: shows a side view of a transport device of the transport system, partially in section;

FIGS. 6 and 7: show a partial representation of containers held by means of the transport device corresponding to detail A in FIG. 3 (FIG. 6) and released containers (FIG. 7);

FIG. 8: shows a schematic representation of movement patterns and transported containers in the transport system in accordance with FIG. 1;

FIG. 9: shows an apparatus in accordance with the invention for processing containers, comprising a transport system in accordance with the invention, in each case in a preferred embodiment;

FIG. 10: shows an apparatus in accordance with the invention for processing containers, comprising a transport system in accordance with the invention, in each case in a preferred embodiment;

FIGS. 11 and 12: show schematic movement patterns of transport devices of the transport system in accordance with FIG. 10 and containers transported with the transport devices, wherein FIGS. 11 and 12, joined together along the corresponding line marked B, are to be considered as a common figure; and

FIG. 13: shows a perspective representation of a transport device and a holding station of an apparatus in accordance with the invention in a perspective representation.

### DETAILED DESCRIPTION

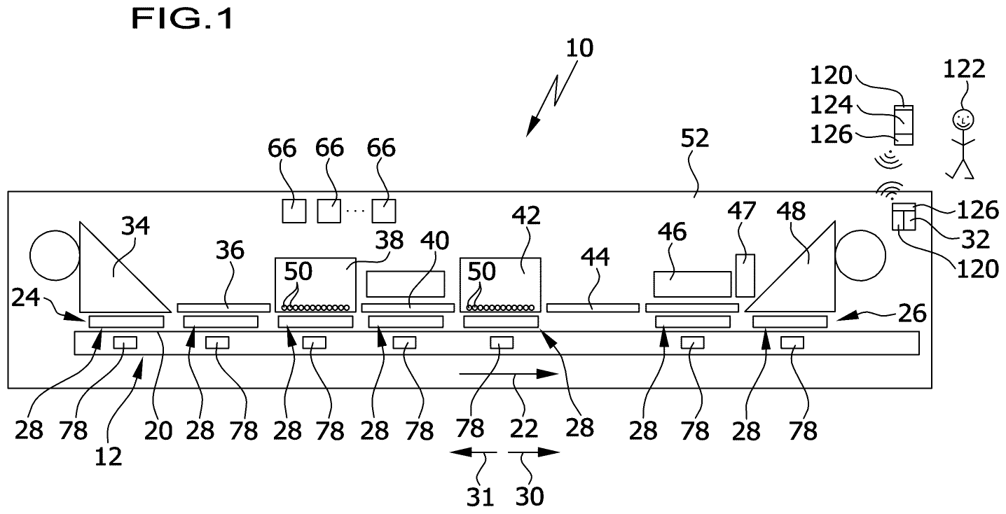

FIG. 1 shows an advantageous embodiment, designated as a whole by reference numeral 10, of the apparatus in accordance with the invention for processing pharmaceutical containers. The apparatus 10 comprises a preferred embodiment of the transport system 12 in accordance with the invention. A preferred exemplary embodiment of the method in accordance with the invention can be realized with the transport system 12 and the apparatus 10.

The transport system 12 is described below using the example of transport of containers 14 which are processed via the apparatus 10. In the present example, the containers 14 are pharmaceutical containers, in particular vials 16. The vials 16 are stable containers which, due to their geometry, can stand independently on a set-down element.

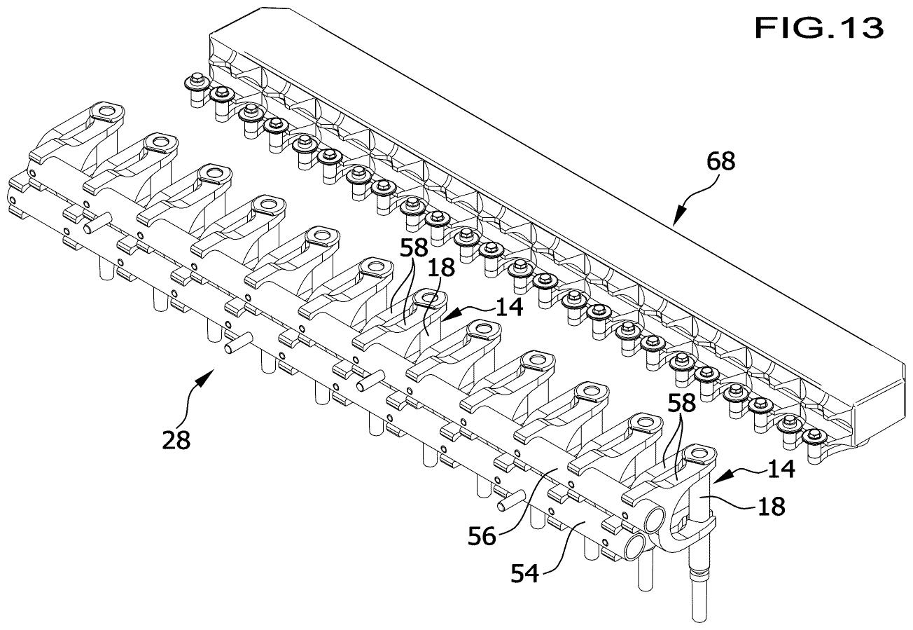

The transport system 12 is also suitable for processing other types of containers. This is discussed below using the example of FIG. 13, which represents syringes 18 as containers 14 to be transported.

The transport system 12 shown merely schematically in FIG. 1 comprises a transport path 20, which defines a transport direction 22. The transport path 20 extends from an inlet 24 to an outlet 26 for the containers 14.

The transport path 20 extends linearly, and the transport direction 22 is linearly aligned.

The transport system 12 further comprises a plurality of transport devices 28. In the present case, seven transport devices 28 are provided, which are configured in particular identically. Only the design of a transport device is therefore discussed below. The statements in this regard also apply for the rest of the transport devices 28.

In a different advantageous embodiment of the transport system in accordance with the invention, a number of transport devices deviating from seven pieces is used. Two or more transport devices are provided here.

For controlling the transport devices 28, the transport system 12 comprises a preferably electronic control device 32.

The transport devices 28 are positioned one behind the other in the transport direction 22, wherein a first transport device 28 in FIG. 1 is shown at the inlet 24 and a last transport device 28 at the outlet 26. The transport devices 28 can be moved in both orientations 30, 31 along the transport direction 22 as explained below.

In the intended use of the transport system 12, in this way a clocked transport of containers 14 from the inlet 24 to the outlet 26 can take place in the orientation 30, using stations positioned on the transport path. By contrast, in the opposite orientation 31, in the intended use the transport devices 28 move empty, i.e., without containers, in order to receive a new package of containers 14.

In the present example, the apparatus 10 comprises a plurality of stations which are positioned one behind the other on the transport path 20 in the transport direction 22. The stations can also preferably be controlled by the control device 32.

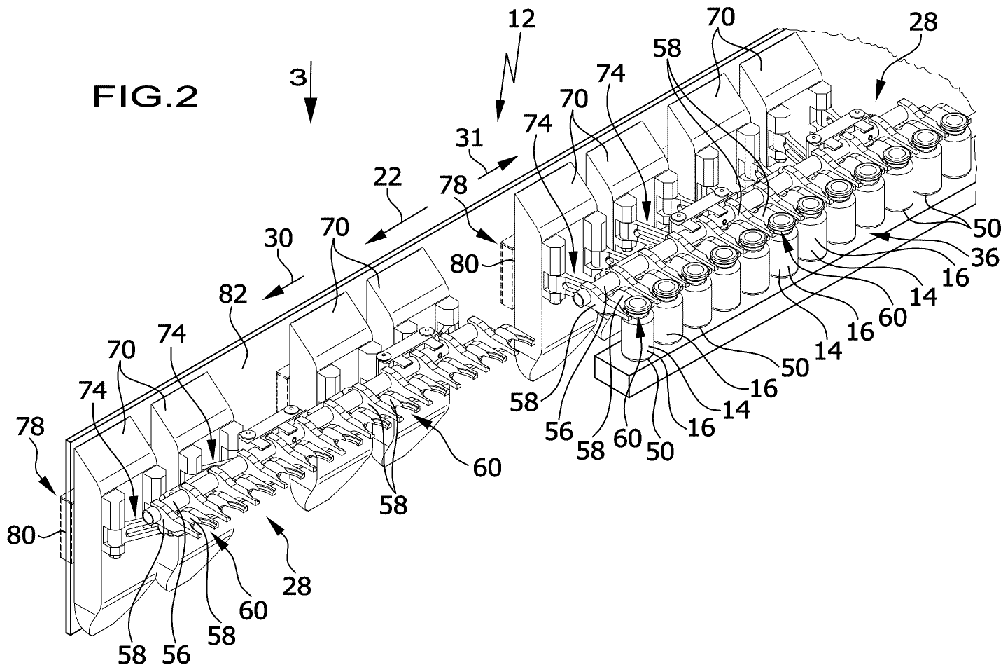

An in-coupling station 34 is provided at the inlet 24. The next station is a set-down station 36 for setting down stable containers 14 (FIGS. 2 to 4, 6, and 7). A first weighing station 38, a filling station 40 and a second weighing station 42 then follow. A further set-down station 44, a closing station 46, a monitoring station 47 and, at the outlet 26, an out-coupling station 48 then follow.

The monitoring station 47 is an example for at least one monitoring station along the transport path 20, which could also be positioned at a different type of position. The monitoring station 47 serves, for example, to monitor a container 14, closure elements, and/or the color of a substance in the container 14.

The containers 14 to be processed are supplied via the in-coupling station 34, “temporarily parked” on the set-down station 36, weighed at the weighing station 38 in an empty state (tare weighing), filled via the filling station 40 with filling elements (for example filling needles) positioned thereon, weighed at the second weighing station 42 in the filled state (gross weighing), “temporarily parked” at the further set-down station 44, closed at the closing station 46 by means of closure elements, and coupled out via the out-coupling station 48 at the outlet 26.

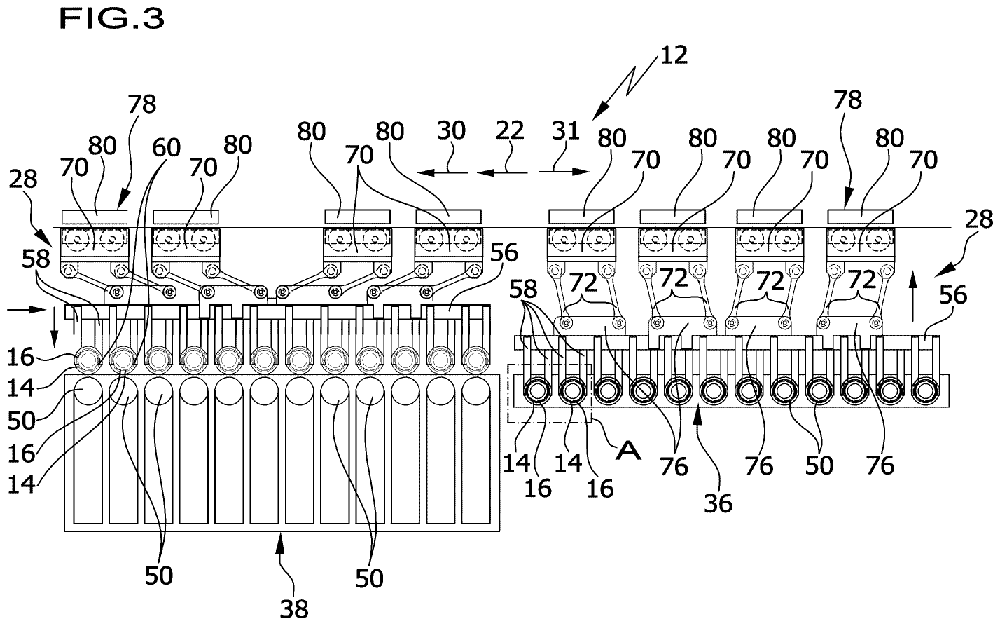

A respective station 34 to 48 defines a plurality of container locations 50, at each of which a container 14 can be positioned. In the present exemplary embodiment, all stations 34 to 48 each comprise twelve container locations 50, for example, wherein their number could also be different. By way of example, FIGS. 1 and 3 show container locations 50 at the weighing stations 38 and 42. FIGS. 2 to 4, 6 and 7 show the container locations 50 of the first set-down station 36.

In the present exemplary embodiment, the spatial positions of the container locations 50 are predetermined. In the processing stations 38, 40, 42 and 46, the positions of the container locations 50 are defined by the design of these stations. In the case of the set-down stations 36 and 44, the positions of the container locations 50 are specified by the programming of the transport system 12, for example by the user. At the in-coupling station 34 and at the out-coupling station 48, the positions of the container locations 50 also result through the design of these two stations.

A respective distance of adjacent container locations 50 (“pitch”) at the stations 34 to 48 is identical. In addition, all stations 34 to 48 have an identical pitch.

It is understood that the stations 34 to 48, this is not shown in the drawing, are preferably positioned and held on a frame 52 or substructure of the apparatus 10.

The apparatus 10 can comprise an insulating device covering the frame 52, for example, via which an atmosphere can be provided. This is, for example, an atmosphere for the purpose of decontamination, for example by means of H₂O₂.

Overall, it is advantageous if the apparatus 10 has a pharmaceutically acceptable design, for the purpose of which the suitable materials, such as stainless steel and/or plastic, can be used.

In the following, the embodiment of the corresponding transport device 28 is first discussed in particular with reference to FIGS. 2 to 7.

In functional terms, the transport device 28 is substantially designed as described in DE 10 2018 213 800 A1 of the same patent applicant, the content of which is incorporated in its entirety into the present disclosure. In terms of design, further refinements result in the present embodiment of the transport system 12.

The transport device 28 comprises a first holding part 54 and a second holding part 56. The holding parts 54, 56 are preferably identical or functionally identical and elongate, for example in the form of tubes. The holding parts 54, 56 are aligned along the transport direction 22.

In the present case, a plurality of holding elements 58 are fixed to a corresponding holding part 54. In the present case, each transport device 28 comprises twelve holding elements 58 on each holding part 54, 56, wherein their number could also be different.

A holding element 58 on the first holding part 54 and a holding element 58 on the second holding part 56 together form a container receptacle 60. Accordingly, the transport device 28 in the present example comprises twelve container receptacles 60, the number of which could also be different.

A corresponding container receptacle 60 defines a transport location of the transport device 28. The number of container receptacles 60 thus corresponds to the number of transport locations of the transport device 28.

The distances between adjacent container receptacles 60 (“pitch”) are identical in the present case. In particular, the pitch of the transport device 28 corresponds to the pitch of the stations of the stations 34 to 48, so that the apparatus 10 overall has a constant pitch.

A container 14 can be held in each container receptacle 60.

The transport device 28 is designed to move the containers 14 in the container receptacles 60 along the transport direction 22. From the inlet 24 to the outlet 26, the movement takes place in the orientation 30. However, a movement in the orientation 31 can in particular be provided, conversely.

A movement in the orientation 31 proves to be advantageous, for example, during process monitoring of the apparatus 10. For example, if the second weighing station 42 determines that a container 14 is underfilled, the container 14 can be transported back to the filling station 40 and re-filled.

The transport device 28 is also designed to move the containers 14 transversely and/or perpendicularly to the transport direction 22.

For example, the containers 14 can thus be handed over by the transport device 28 to the stations 36 to 48; a handover to the in-coupling station 34 is not customary, however, this can be provided.

In a corresponding manner, the containers 14 can be taken over from the stations 34 to 46 by means of the transport device 28. A takeover from the out-coupling station 48 is not customary, but can nevertheless be provided.

By means of the transport system 12, the containers 14 can accordingly be “brought” to or conversely “picked up” from the stations 34 to 48. It can be favorable in particular if the stations 34 to 48 are in turn positioned so as to be stationary on the apparatus 10 such that they do not transport the containers 14 themselves.

It will be understood that, as will be discussed below, that not every station 34 to 48 can be approached by each transport device 28. However, preferably, at least the stations 36 to 46 can be reached by at least two transport devices 28.

In the present case, the holding elements 58 are releasably fixable to the holding parts 54, 56. It is favorable, for example, if the holding elements 58 can be fixed and/or released manually and/or without tools.

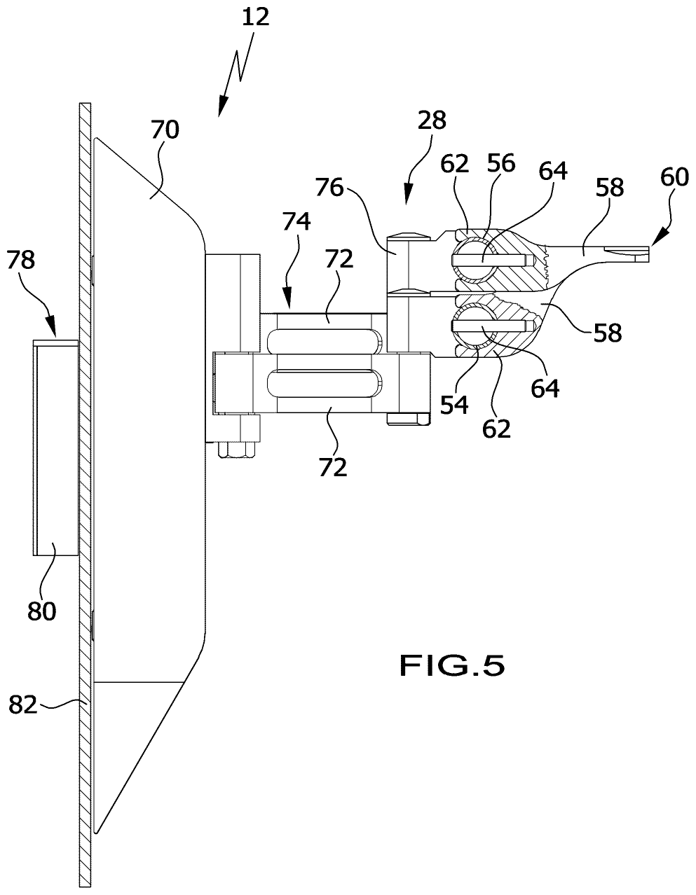

FIG. 5 shows, for example, a force-locking and preferably positive-locking fastening of the holding elements 58 via a substantially C-shaped holding portion 62. The holding portion 62 is snapped onto the holding part 54 or 56. An anti-twist member 64 is associated with a corresponding holding element 58 in order to prevent rotation of the holding element 58 relative to the holding part 54, 56. In the present case, the anti-twist member 64 is, for example, a pin which is in engagement with the holding element 58 and the holding part 54, 56.

The holding elements 58 cover a predetermined format range in order to be able to process containers 14 of different natures. The holding elements 58 are part of a format set 66 (FIG. 1).

The transport system 12 can comprise further format sets 66 with holding elements 58 which differ from those of the first-mentioned format set 66 with regard to a container-specific property and/or container-component-specific property. This provides the possibility of replacing only the holding elements 58 in the transport devices 28 and thereby transporting a different type of format range, for example different types of container and/or containers 14 with different dimensions.

For example, FIG. 13 shows holding elements 58 for the containers 14 configured as syringes 18 in this case. The holding elements 58 can be designed, for example, as “Gripping elements”, as described in DE 10 2022 102 012.6 by the same applicant with the same filing date, 28 Jan. 2022, entitled “Gripping device for gripping a container and holding device with a gripping device”. The disclosure of that patent application is incorporated in its entirety into the present patent application.

If the holding elements 58 are used for the syringes 18, a holding station 68 can be used, for example, instead of the set-down stations 36 and 44 in order to “temporarily park” the syringes 18. The non-stable syringes 18 can be held suspended in the holding station 68 by force locking and/or positive locking.

The holding station 68 can be designed, for example, as a “Holding device”, as described in the patent application with the application number DE 10 2022 101 994.2 by the same applicant with the same filing date, 28 Jan. 2022, entitled “Holding device for a container and device for processing containers”. The disclosure of that patent application is incorporated in its entirety into the present patent application.

In the present example, the transport device 28 comprises four transport elements 70, two of which are associated with the holding part 54 and two with the holding part 56. Each transport element 70 is hingedly connected to the holding part 54 or 56 via coupling elements 72. In this way, a four-bar linkage designed as a joint parallelogram 74, which has a coupling member 76 on the holding part side, is formed.

The transport elements 70 are part of a drive unit 78 of the transport device 28. The drive unit 78 comprises a drive element 80 associated with a respective transport element 70. FIGS. 1, 9 and 10 show the drive unit 78 schematically in its positioning on the transport path 20, in particular FIGS. 3 to 5, the transport device 28 with the holding parts 54, 56 and the drive unit 78.

The drive elements 80 are magnetically coupled to the transport elements 70 in the present case. The coupling takes place through the transport path 20, the side of which remote from the transport elements 70 can be electrically acted upon under control by the control device 32 such that alternating magnetic fields can be generated. These magnetic fields make it possible to specify the positions of the drive elements 80 and thereby the position of the transport device 28 on the whole, in particular of the container receptacles 60.

In particular, there is the possibility of moving the transport device 28 along the transport direction 22 as mentioned.

In addition, there is the possibility of moving the container receptacles 60 transversely and in particular perpendicularly to the transport direction 22. For example, a movement component oriented at an angle of greater than 0° to 90° relative to the transport direction 22 can be implemented, as has already been explained above.

With respect to the mechanism for moving the transport device 28 on the transport path 20, the opening and closing of the container receptacles 60 and the approach to the handover to the stations 34 to 48 and the removal for receiving containers 14 from the stations 34 to 48, reference is made to the above-mentioned DE 10 2018 213 800 A1.

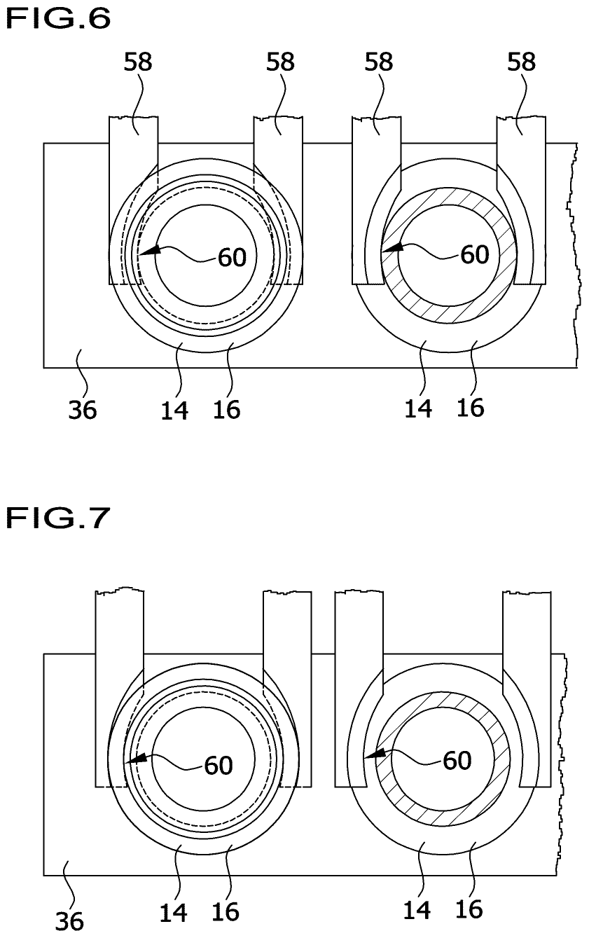

The holding parts 54, 56 can assume a holding position in which the containers 14 are held in the container receptacle 60 (FIG. 3, FIG. 6). In the holding position of the holding parts 54, 56, the containers 14 can be moved with the transport device 28.

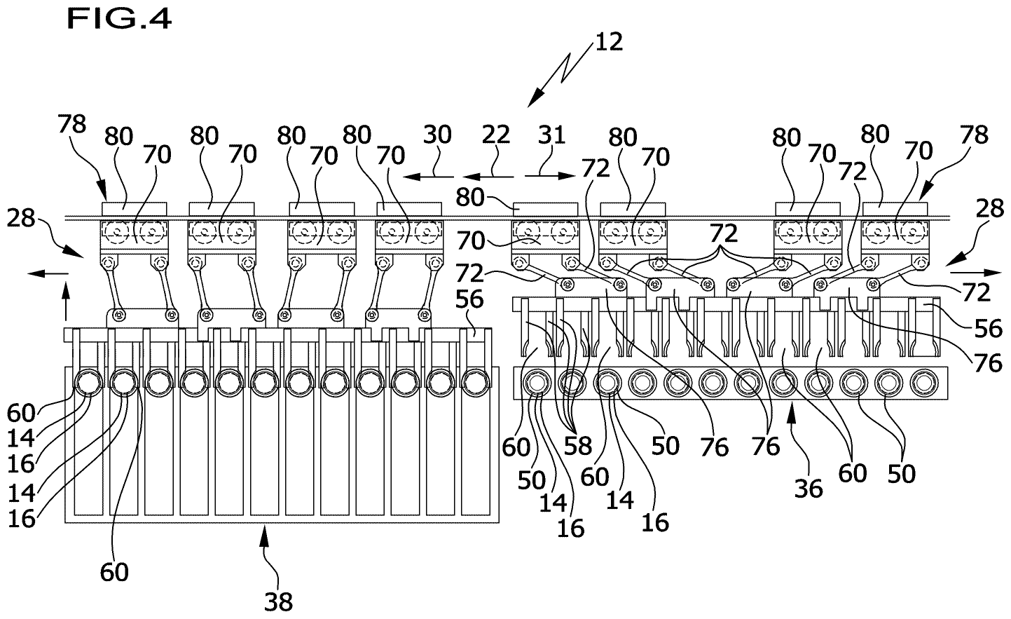

Via the drive unit 78, the holding parts 54, 56 can be transferred relative to one another into a release position in which the container receptacles 60 are released (FIG. 4, FIG. 7). This makes it possible to hand over the containers 14 to the stations 34 to 48 or take them over from said stations.

The transport locations of the transport device are to a certain extent variable in size when the holding parts 54, 56 are transferred relative to one another into the holding position or into the release position, wherein the number of transport locations in particular does not change here.

It is particularly advantageous in the transport system 12 that a corresponding transport device 28 can be controlled individually by the control device 32. In particular, the transport devices 28 can preferably be controllable with regard to at least one of the following:
a travel path along the transport direction 22. In this case, it is preferably possible to set and/or modify an overlap of the ranges of movement of transport devices 28.
a travel speed along the transport direction 22;
an acceleration along the transport direction 22;
a standstill time, during which the transport device 28 is not moved along the transport direction 22;
a ratio of a travel time to a standstill time.
a movement of the containers 14 transversely and/or perpendicularly to the transport direction 22 for handing over the containers 14 to the stations 34 to 48 and/or for taking over the containers 14 from the station 34 to 48;
a travel speed and/or an acceleration here;
a standstill time, during which the transport device 28 is positioned unmoved at the at least one station 34 to 48;
a ratio of a travel time to a standstill time here;
a time behavior for closing the container receptacles 60 for receiving the containers 14 and/or for opening the container receptacles 60 for releasing the containers 14.

The above statements show that, for the containers 14 held in the container receptacles 60, a trajectory is predeterminable by controlling the control device 32 during the movement of a corresponding transport device 28. As a result, the transport system 12 has a particularly high versatility.

A corresponding transport device 28 is preferably individually controllable by the control device 32 with regard to at least one of the following:
at least one movement parameter of at least one further transport device 28, for example location, speed, acceleration, and/or standstill time;
a type of the at least one station 34 to 48;
a dwell time of the containers 14 at the at least one station 34 to 48;
a nature of the containers 14;
a handover duration for the handover of the containers 14 to the at least one station 34 to 48;
a takeover duration for takeover the containers 14 from the at least one station 34 to 48;
at least one input parameter of the control device 32, for example a signal, in particular an interference signal.

In particular, a corresponding control of the transport device 28 during operation of the transport system 12 can be variable in respect of a particularly versatile embodiment.

The holding parts 54, 56 can preferably be controlled by the control device 32 for movement independently of one another, in particular depending on the type of containers 14 to be processed. The holding elements 58 of the holding parts 54, 56 can have different types of trajectories, for example:

The holding elements 58 are applied to the container 14 on sides facing away from one another (referred to above as the left side and the right side). In the case of the vials 16, which are gripped at the neck, the attachable portions can be designed to be symmetrical to one another. Trajectories of the holding elements 58, via the movement of the holding parts 54, 56, can be symmetrical to one another.

By contrast, for example in containers 14 in the form of syringes 18, the shape of the holding elements on the attachable portions is different and in particular asymmetrical (FIG. 13) in order to ensure reliable retention of the syringes 18 externally at the lateral surface. Trajectories of the holding elements 58, via the holding parts 54, 56, can be asymmetrical in particular at the time of handover and/or takeover.

At least two of the transport devices 28 can be movable simultaneously. The movement can be carried out in the same orientation or in mutually opposite orientations.

The ranges of movement of at least in each case adjacent transport devices 28 in the transport system 12 overlap in such a way that at least some of the container locations 50, preferably all of the container locations 50, of at least the stations 36 to 46 can be reached by two or more transport devices 28. This offers in particular the possibility of transporting the containers 14 successively via the transport devices 28 positioned one behind the other in the transport direction 22.

Compared to a conventional transport system, this offers, for example, an advantage of a lower moving mass and lower torques, so that faster transport can be carried out. Component tolerances are less pronounced, and interim mounting points as in the prior art are not required. With regard to any process monitoring and fault finding, the transport devices 28 can be stopped independently of one another. This makes it easier to determine the cause of a disturbance. Preferably, not all containers 14 in the transport system 12 have to be discarded here, but only the containers 14 of a disturbed transport device 28.

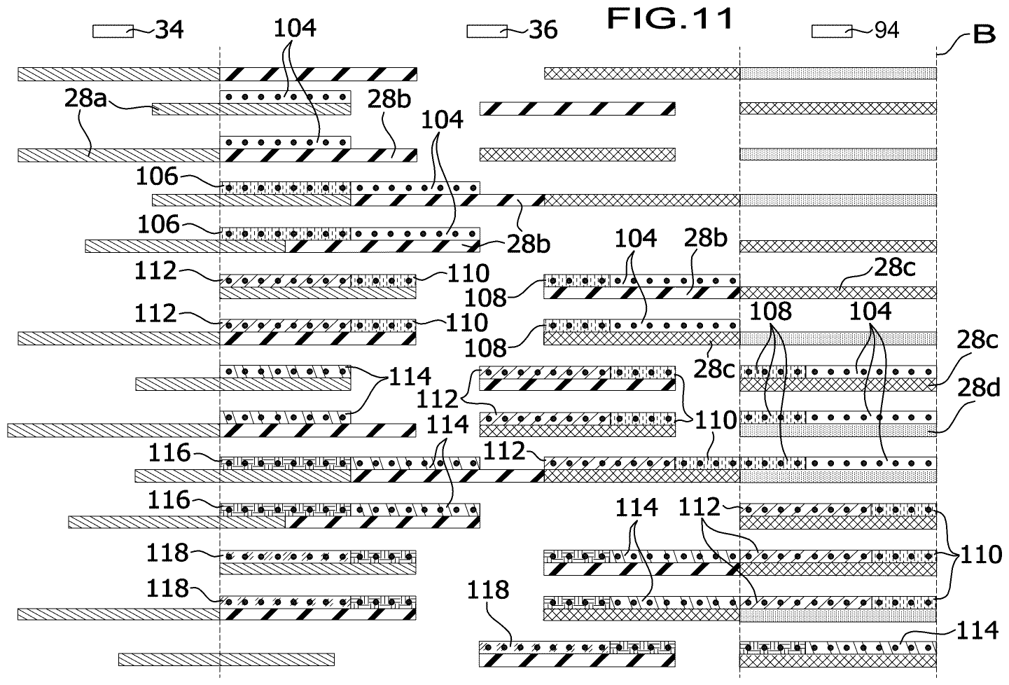

A further advantage is in particular that the transport devices 28 can be controlled flexibly independently of one another in order to implement the different trajectories and to transfer different numbers of containers 14 to the stations and/or to receive them therefrom. This will be discussed below in particular with reference to FIGS. 10 and 12.

In the apparatus 10, the numbers of the container receptacles 60 of the transport devices 28—i.e., the number of positions of the transport devices 28—coincide with the number of container locations 50 of the stations 34 to 48. With regard to a high clock cycle of the apparatus 10, all container receptacles 60 and all container locations 50 are used, i.e., loaded with containers 14.

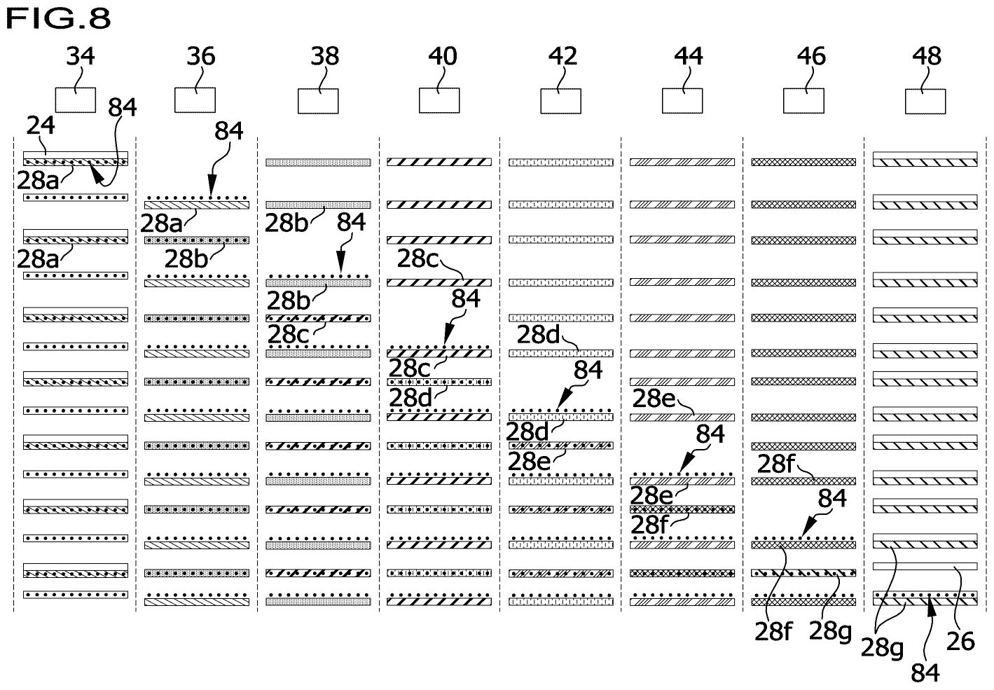

FIG. 8 shows, by way of example, movement patterns of the transport devices, which are marked there with the reference numerals 28a to 28g and can be seen on the basis of their texture. The respective stations are marked on the upper side in FIG. 8 via the reference numerals 34 to 48. Containers 14 are characterized by a corresponding black point.

The containers 14 are processed in cycles by moving the transport devices 28 back and forth in a clocked manner along the transport direction 22. In this case, packages of containers 14 are supplied successively.

A first package 84 of containers 14 is removed from the in-coupling station 34 by the transport device 28a and brought to the set-down station 36. Subsequently, the transport device 28a always moves between the stations 34 and 36 and repeatedly feeds further packages of containers 14.

The transport device 28b moves between the stations 36 and 38. It picks up the package 84 from the set-down station 36 and brings it to the weighing station 38.

The transport device 28c moves between the stations 38 and 40. It picks up the package 84 from the weighing station 38 and brings it to the filling station 40.

The transport device 28d moves between the stations 40 and 42. It picks up the package 84 from the filling station 40 and brings it to the weighing station 42.

The transport device 28e moves between the stations 42 and 44. It picks up the package 84 from the weighing station 42 and brings it to the set-down station 44.

The transport device 28f moves between the stations 44 and 46. It picks up the package 84 from the set-down station 44 and brings it to the closing station 46.

The transport device 28g moves between the stations 46 and 48. It picks up the package 84 from the closing station 46 and brings it to the out-coupling station 48.

In this case, all twelve containers 14 are in any case moved with the transport devices 28 and processed at the stations 34 to 48.

FIGS. 3 and 4 show the stations 36 and 38 with 2 packages of 12 containers 14 each. In the representation in accordance with FIG. 3, the corresponding package is deposited (station 36) or supplied (station 38). In the illustration in accordance with FIG. 4, the transport device 28 is retracted in order to pick up a new package (station 36) or set down the package (station 38).

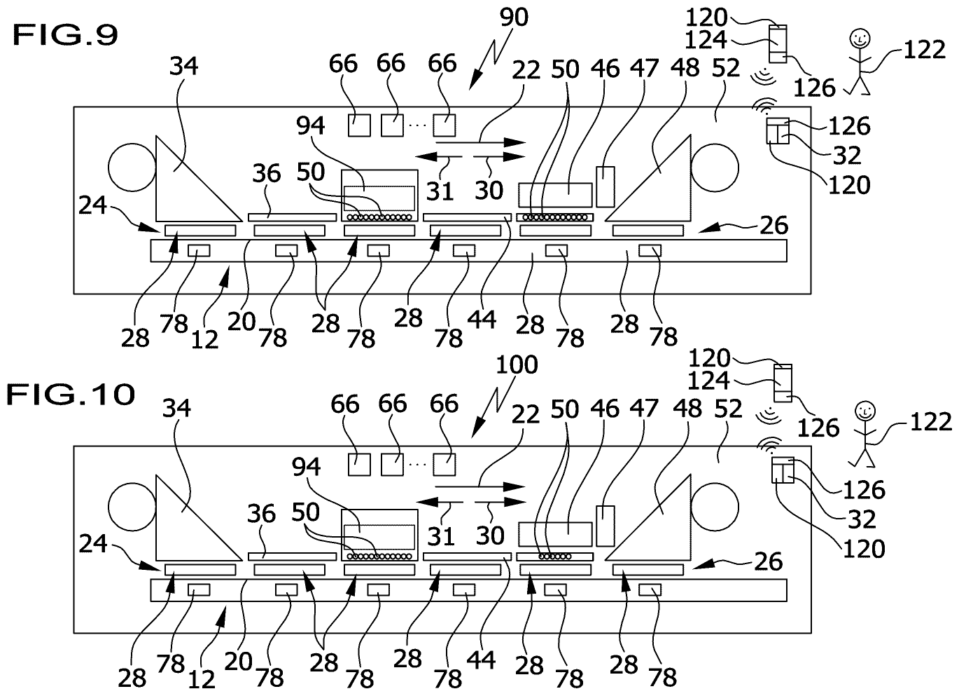

In the following, the apparatuses 90, 100 in accordance with the invention, shown schematically in FIGS. 9 and 10, with transport systems 92, 102 in accordance with the invention are discussed, in each case in a preferred embodiment.

The properties and advantages mentioned in conjunction with the apparatus 10 and the transport system 12 can also be achieved with the apparatuses 90, 100 and the transport systems 92, 102. In this regard, reference is made to the above statements in order to avoid repetitions. Only the major differences will be discussed.

In the apparatus 90 in accordance with FIG. 9, the transport system 92 is configured to be largely identical to the transport system 12. In a deviation from this, it comprises only six instead of seven transport devices 28.

A twelve-location clocked transport takes place in each case in the apparatus 90 as well, wherein the respective stations have twelve container locations 50.

In the apparatus 90, a combined weighing and filling station 94 is used instead of weighing stations 38 and 42 and the filling station 40. In this case, it is possible to weigh at the same station 94 during the filling process and/or to determine first the tare weight and then the gross weight.

Otherwise, the stations 34, 36, 44, 46 and 48 correspond to the corresponding stations of the apparatus 10. In particular, the closing station 46 is also designed to have twelve locations in the apparatus 90.

In the apparatus 100, the transport system 102 corresponds to the transport system 92 of the apparatus 90. In terms of design, this matches the transport system 12 in accordance with FIG. 1, apart from the number of transport devices 28.

By contrast, the closing station 46 in the apparatus 100 is designed with only eight container locations 50. The stations 34, 38 and 48 also comprise twelve container locations 50 as the transport devices 28 comprise twelve container receptacles 60. The set-down stations 36 and 44 can preferably have a greater number of locations.

However, the possibility of individually controlling the transport devices 28 provides in particular the possibility of approaching the closing station 46 in eight locations and the weighing and filling station 94 in twelve locations. The set-down stations 36, 44 can selectively be approached in eight locations or twelve locations.

In the present example, the containers 14 are taken over at the in-coupling station 34 at eight positions and are handed over at the out-coupling station 48 (not shown) likewise at eight positions.

For the containers 14, the weighing and filling station 94 requires a longer dwell time than the closing station 46. For this reason, it is expedient if the highest possible number of containers 14 is processed at the weighing and filling station 94. All of the twelve containers 14 transportable via the transport devices 28 can preferably be processed here.

By contrast, there is the possibility of processing containers 14 in an eight-step clock cycle at the “faster” closing station 46 in comparison to the weighing and filling station 94.

It goes without saying that the present exemplary embodiment with a twelve-step clock cycle on the one hand and an eight-step clock cycle on the other hand is only used by way of example in order to explain the possibility of an individual clock cycle which can be run with each of the transport devices 28.

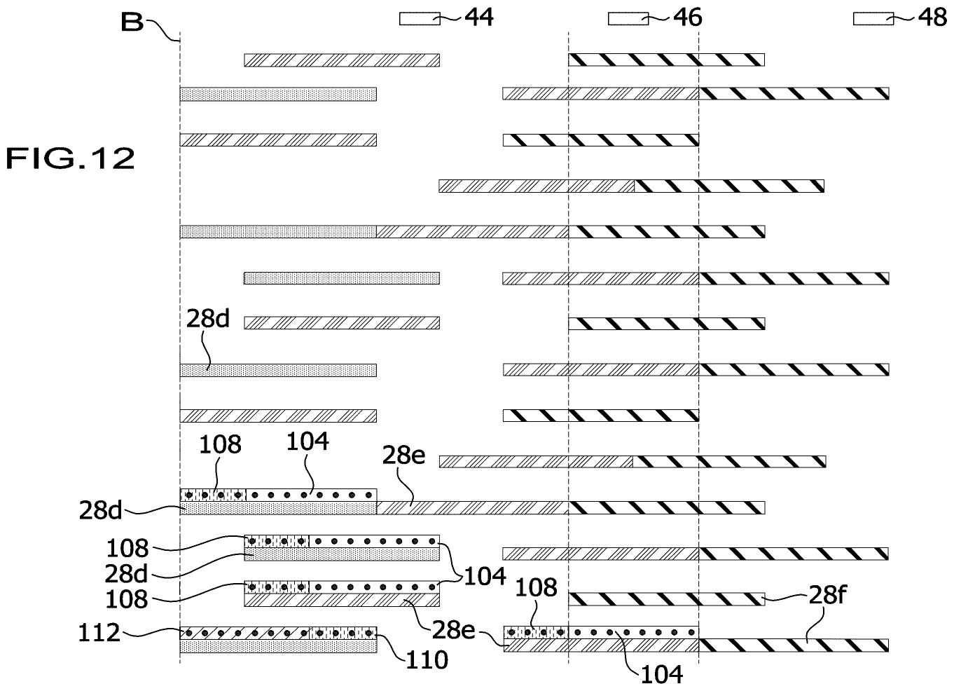

With reference to FIGS. 11 and 12, movement patterns of the transport devices, which are designated there with the reference numerals 28a to 28f and can be recognized on the basis of their texture, are described by way of example for a first package 104 and a further second package 106.

The same packages or their package segments are characterized by the same texture in FIGS. 11 and 12.

From the in-coupling station 34, the transport device 28a takes over a package 104 with eight containers 14 and transports it to the set-down station 36.

The package 104 is handed over to the transport device 28b.

In a subsequent step, the transport device 28a transports a further package 106 with eight containers 14 to the set-down station 36.

The transport device 28 takes over herefrom a package segment 108 with four containers 14, whereas a further package segment 110 with a further four containers 14 remains at the set-down station 36. A third package 112 with eight containers 14 is added to this package segment 110 via the transport device 28a.

Via the set-down station 36, the package 104 and the package segment 108, temporarily parked, can be taken over by the transport device 28c and transported at twelve locations to the weighing and filling station 94.

A transport device 28d picks up the package 104 and the package segment 108 from the weighing and filling station 94 and transports them to the set-down station 44.

A subsequent transport device 28e picks up the package 106 and the package segment 108 and travels to the closing station 46. The package 104 with eight containers 14 is handed over to the closing station 46. By contrast, the containers 14 of the package segment 108 are “temporarily parked” at the set-down station 44.

In a subsequent step (not shown), a transport device 28f can takes over the eight containers 14 of the package 104 and transports them to the out-coupling station 48.

Meanwhile, the transport device 28d has transported the package segment 110 and the package 112 to the set-down station 44. In this case, the package segment 110 can in particular be positioned laterally next to the package segment 108, so that, in a subsequent step, the transport device 28e can transport the original package 106 in the eight-step clock cycle and hand over it to the closing station 46.

The reference numerals 114, 116 and 118 identify packages subsequently supplied by means of the transport device 28a, which packages, if necessary, in the respective further course of their transport, can be divided into individual package segments in accordance with the manner described above in order to achieve twelve-location processing at the weighing and filling station 94 and eight-location processing at the closing station 46.

The control device 32 comprises a programming interface 120 via which an operator 122 can provide programming information. Alternatively or additionally, the control device 32 can, for example, be coupled wirelessly and/or can be wired to an external auxiliary unit 124 for the operator 122, which comprises a programming interface 120. In particular, via the programming interface 120, the possibility exists of programming the transport systems 12, 92, and 102 as well as the apparatuses 10, 90 and 100 with regard to the task to be performed. For coupling, the control device 32 and the auxiliary unit can each comprise a communication member 126.

### LIST OF REFERENCE NUMERALS

10, 90, 100 Apparatus
12, 92, 102 Transport system
14 Container
16 Vial
18 Syringe
20 Transport path
22 Transport direction
24 Inlet
26 Outlet
28 Transport device
30, 31 Orientation
32 Control device
34 In-coupling station
36 Set-down station
38 Weighing station
40 Filling station
42 Weighing station
44 Set-down station
46 Closing station
48 Out-coupling station
50 Container location
52 Frame
54, 56 Holding part
58 Holding element
60 Container receptacle
62 Holding portion
64 Anti-twist member
66 Format set
68 Holding station
70 Transport element
72 Coupling element
74 Joint parallelogram
76 Coupling member
78 Drive unit
80 Drive element
84, 104, 106, 112, 114, 116, 118 Package
94 Weighing and filling station
108, 110 Package segment
120 Programming interface
122 Operator
124 Auxiliary unit
126 Communication member

1. A transport system for transporting pharmaceutical containers, the transport system comprising:
an extended transport path which defines a transport direction, from an inlet to an outlet, wherein at least one station for the containers is positioned or positionable on the extended transport path and comprises or defines a plurality of container locations;
two or more transport devices positioned one behind another along the transport direction, each of the two or more transport devices comprising a plurality of container receptacles, the two or more transport devices designed to be moved back and forth independently of one another in a clocked manner along the transport direction so as to move containers in a clocked transport, and to hand over containers to the at least one station and/or to take over containers from the at least one station; and
a control device for controlling the transport devices, wherein a range of movement of the transport devices overlaps along the transport direction in such a way that at least a portion of the container locations of the at least one station is reachable by two or more transport devices.

2. The transport system according to claim 1, wherein a range of movement of the transport devices overlaps along the transport direction such that all container locations of the at least one station are reachable by means of two or more transport devices.

3. The transport system according to claim 1, wherein a range of movement of the transport devices overlaps along the transport direction in such a way that at least one of the transport devices is positionable along the transport direction, at least in portions, on sides of the at least one station facing away from one another.

4. The transport system according to claim 1, wherein the transport system comprises more than two transport devices positioned one behind another in the transport direction, and in that the ranges of movement of three or more transport devices overlap, in such a way that at least some of the container locations of the at least one station is reachable by means of three or more transport devices.

5. The transport system according to claim 1, wherein at least one transport device is controllable individually by the control device with regard to at least one of:
a travel path along the transport direction;
a travel speed along the transport direction;
an acceleration along the transport direction;
a standstill time, during which the transport device is not moved along the transport direction;
a ratio of a travel time to a standstill time.

6. The transport system according to claim 1, wherein at least one transport device is controllable individually by the control device with regard to at least one of:
a movement of the containers transversely and/or perpendicularly to the transport direction for handing over the containers to the station and/or for taking over the containers from the station;
a travel speed and/or an acceleration here;
a standstill time, during which the transport device is positioned unmoved at the at least one station;
a ratio of a travel time to a standstill time here;
a time behavior for closing the container receptacles for receiving the containers and/or for opening the container receptacles for releasing the containers.

7. The transport system according to claim 6, wherein control of at least one transport device is changeable during operation of the transport system.

8. The transport system according to claim 1, wherein at least one transport device is controllable by the control device with regard to a trajectory of the container receptacles during movement of the transport device.

9. The transport system according to claim 1, wherein by individually controlling at least one transport device of the at least one transport device, a separate clock cycle is executable during operation.

10. The transport system according to claim 1, wherein at least one transport device is controllable individually by the control device depending on at least one of:
at least one movement parameter of at least one further transport device, the at least one movement parameter comprising location, speed, acceleration, and/or standstill time;
a type of the at least one station;
a dwell time of the containers at the at least one station;
a nature of the containers;
a transfer duration for the transfer of the containers to the at least one station;
a removal duration for removing the containers from the at least one station;
at least one input parameter of the control device comprising a signal.

11. The transport system according to claim 1, wherein the plurality of container locations comprises a number of container locations, and wherein a travel path of the transport devices along the transport direction is adjustable independently of the number of container locations.

12. The transport system according to claim 11, wherein the plurality of container receptacles comprises a number of container receptacles, and wherein the number of container receptacles corresponds to the number of container locations.

13. The transport system according to claim 12, wherein the number of container receptacles of the transport devices differs from the number of container locations of the at least one station.

14. The transport system according to claim 1, wherein the clocked transport of containers via the transport devices is executable in such a way that, by means of at least one of the transport devices, all containers held in the container receptacles are configured to be handed over to the at least one station and/or all containers positioned at the container locations are configured to be taken over from the at least one station.

15. The transport system according to claim 1, wherein the clocked transport of containers via the transport devices is executable in such a way that, by means of the transport devices, only some of the containers held in the container receptacles are configured to be handed over to the at least one station and/or only some of the containers positioned at the container locations are configured to be taken over from the at least one station.

16. The transport system according to claim 1, wherein two or more transport devices are configured identical.

17. The transport system according to claim 1, wherein a distance of adjacent container receptacles in the two or more transport devices and/or within a corresponding transport device coincides.

18. The transport system according to claim 1, wherein a distance of adjacent container locations of the at least one station corresponds to a distance of the container receptacles of the transport devices or is an integer multiple of the distance of the container receptacles of the transport devices from one another.

19. The transport system according to claim 1, wherein the containers are movable in discrete intervals along the transport direction and/or continuously via at least one of the transport devices.

20. The transport system according to claim 1, wherein a spatial position of the container locations at the at least one station is fixedly predetermined or freely predeterminable.

21. The transport system according to claim 1, wherein the transport system is of a pharmaceutically suitable design.

22. The transport system according to claim 1, wherein two or more transport devices are controllable by the control device such that they are movable simultaneously along the transport direction.

23. The transport system according to claim 1, wherein two or more transport devices are controllable by the control device such that said two or more transport devices are movable synchronously along the transport direction at a same speed and/or a same acceleration.

24. The transport system according to claim 1, wherein the transport devices each comprise at least one holding part and a plurality of holding elements which form the container receptacles.

25. The transport system according to claim 24, wherein the transport system comprises two or more format sets which each comprise holding elements, wherein the holding elements of different format sets differ from one another with regard to at least one container-specific and/or container component-specific property, wherein the holding elements of a corresponding format set are selectively fixable to the holding parts.

26. The transport system according to claim 24, wherein the transport device comprises two holding parts which are movable relative to one another along the transport direction and on which holding elements are positioned in each case, wherein a corresponding container receptacle is formed by two holding elements, with the holding elements on one each of the holding parts, wherein the holding parts are designed to assume a holding position, in which the containers are held in the container receptacles, and a release position, in which the container receptacles are released.

27. The transport system according to claim 26, wherein at least one transport device is controllable by the control device such that the holding parts of the transport device are movable independently of one another.

28. The transport system according to claim 27, wherein control takes place in such a way that the holding elements of one holding part and the holding elements of another holding part have different types of trajectories.

29. The transport system according to claim 26, wherein the transport device comprises a drive unit for moving the transport device along the transport direction and/or for moving the holding parts relative to one another and/or for moving the holding elements transversely and/or perpendicularly relative to the transport direction.

30. The transport system according to claim 29, wherein the drive unit comprises transport elements coupled in an articulated manner to the holding parts, and drive elements, which are coupled to the transport elements and are movable on the extended transport path along the transport direction.

31. The transport system according to claim 1, wherein the control device comprises a programming interface for an operator and/or a communication member for exchanging programming information with an external auxiliary unit having a programming interface, wherein programming information are providable via the programming interface.

32. An apparatus for processing pharmaceutical containers, the apparatus comprising:
the transport system according to claim 1; and
at least one station positioned on the extended transport path of the transport system,
wherein the plurality of container locations comprises a number of container locations,
and the plurality of container receptacles comprises a number of container receptacles.

33. The apparatus according to claim 32, wherein the at least one station is configured to be active or passive.

34. The apparatus according to claim 32, wherein the at least one station comprises two or more stations positioned one behind another in the transport direction on the extended transport path.

35. The apparatus according to claim 32, wherein the at least one station comprises at least one of:
a set-down station for setting down stable containers;
a holding station for holding non-stable containers;
a weighing station for weighing unfilled and/or filled containers;
a filling station for filling containers;
a closing station for closing containers;
a monitoring station;
a combination of two or more of said set-down station, holding station, weighing station, filling station, closing station and monitoring station;
an in-coupling station for taking over the containers by a transport device that is first in the transport direction; and
an out-coupling station to which the containers are configured to be handed over through a station that is last in the transport direction.

36. The apparatus according to claim 32, further comprising two or more stations, wherein at least two stations comprises container locations that are identical.

37. The apparatus according to claim 36, wherein a clocked transport is executable in such a way that, by means of the transport devices, all containers held in the container receptacles are configured to be handed over to the at least one station and/or all containers positioned at the container locations are configured to be taken over from the at least one station.

38. The apparatus according to claim 32, further comprising two or more stations, wherein the container locations of at least two stations differ from one another.

39. The apparatus according to claim 38, wherein a station in which a longer dwell time exists for the containers during processing has a higher number of container locations than a station with a shorter dwell time.

40. The apparatus according to claim 32, wherein:
the number of container receptacles differs from the number of container locations of a first station,
a set-down station or a holding station is positioned laterally directly next to the first station in the transport direction, and
some of the containers in the container receptacles are transferable by the transport device to the first station, and some of the containers in the container receptacles are transferable to the set-down station or the holding station.

41. The apparatus according to claim 32, wherein the number of container receptacles corresponds to the number of container locations of the station having a highest number of container locations.

42. A method for transporting pharmaceutical containers by a transport system according to claim 1, the method comprising the steps of:
transporting containers by a first transport device along the transport direction to at least one station in a first orientation;
transferring at least some of the containers from the transport device to the at least one station;
removing the first transport device from the at least one station in a second orientation opposite the first orientation;
moving a second transport device in the second orientation to the at least one station in such a way that the second transport device at least partially overlaps with the position of the first transport device beforehand;
transferring at least some of the containers from the at least one station by the second transport device; and
moving the second transport device in the first orientation away from the at least one station.
